(19) United States
(12) Patent Application Publication
(10) Pub. No.: US 2011/0248066 A1
(43) Pub. Date: Oct. 13, 2011

(54) HAMMER TACKER

(76) Inventors: Chih-Wei HU, Taichung Hsien (TW); Qi-Fu Liao, Taichung Hsien (TW)

(21) Appl. No.: 13/081,214

(22) Filed: Apr. 6, 2011

(30) Foreign Application Priority Data
Apr. 7, 2010 (TW) 099110709

(51) Int. Cl. B25C 5/16

(52) U.S. Cl. 227/127

(57) ABSTRACT

A hammer tacker of the present invention includes a shell, a receiving tank, a magazine and a switch. The shell defines an inner chamber, and it includes a handle and a head which has a bottom opening. The receiving tank defines a space and has an opening facing downward, which communicates the bottom opening of the head. The magazine is slidably received in the receiving tank, and the magazine has a bottom surface on which a retaining slot is formed. The switch is pivotably disposed on the bottom of the shell. The switch has a press portion and a retaining portion, from which a retaining protrusion is extended. The retaining protrusion selectively engages with the retaining slot to prohibit the movement of the magazine. When the press portion is pressed, the retaining protrusion disengages from the retaining slot so that the magazine becomes slidable.

### BACKGROUND OF THE INVENTION

1. Field of the Invention

The present invention relates to a manual nailing device, and more particularly to a hammer tacker.

2. Description of the Prior Art

A conventional hammer tacker includes a handle and a magazine slidably received in the handle. An engagement slot is disposed on a distal end of the handle. An engagement portion is disposed on a distal end of the magazine. The engagement portion is able to engage with the engagement slot so as to keep the magazine in the handle.

When filling nails, tacks, or staples, the user has to operate the hammer tacker with two hands together. One hand holds the hammer tacker. The other hand presses the distal end of the magazine to make the engagement portion disengage from the engagement slot. The magazine is then drawn from the handle. The staples can be filled into the handle after the magazine is departed from the handle.

However, it is inconvenient to fill the staples into the conventional hammer tacker. Users must disengage the magazine with both of user's hands. That is, user can hardly take other tool or apparatus at the same time. Secondly, the magazine should be drawn completely out of the handle before the staples are filled in. For filling staples, user has to leave the magazine aside and take the staples. The magazine may be forgotten or lost in worksite, or the magazine may fall out form a high altitude.

The present invention is, therefore, arisen to obviate or at least mitigate the above mentioned disadvantages.

### SUMMARY OF THE INVENTION

The main object of the present invention is to provide a hammer tacker which can be filled with staples or nails easily and quickly.

To achieve the above and other objects, a hammer tacker of the present invention includes a shell, a magazine, a switch, and a striking mechanism.

The shell defines an inner chamber therein. The shell includes a handle and a head. The head is located at one end of the handle. The head has a bottom opening.

The receiving tank is disposed in the inner chamber. The receiving tank defines a space. The space has an opening facing downward. The space communicates with the bottom opening of the head.

The magazine is slidably received in the receiving tank. A receiving slot is defined between the magazine and the receiving tank. The receiving slot is adapted for nailing units to be received therein. The magazine has a bottom surface. The bottom surface is formed with a retaining slot.

The switch is disposed on a bottom of the shell. The switch is pivotable about an axis. The switch has a press portion and a retaining portion. The press portion and the retaining portion are located at two sides of the axis. The press portion and the retaining portion achieve an operative relationship. A retaining protrusion extends from the retaining portion. The retaining protrusion selectively engages with the retaining slot so as to prohibit movement of the magazine.

The striking mechanism is disposed on the head. The striking mechanism is adapted for striking the nailing units.

Further, the retaining protrusion disengages from the retaining slot when the press portion is pressed, so that the magazine resumes to a slidable condition.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing showing a first embodiment of the present invention;

FIG. 2 is a combination drawing showing a first embodiment of the present invention;

FIG. 3 is an AA profile of FIG. 2;

FIG. 4 is a stereogram showing a first embodiment of the present invention when the switch is pressed.

### DETAILED DESCRIPTION OF THE PREFERRED EMBODIMENTS

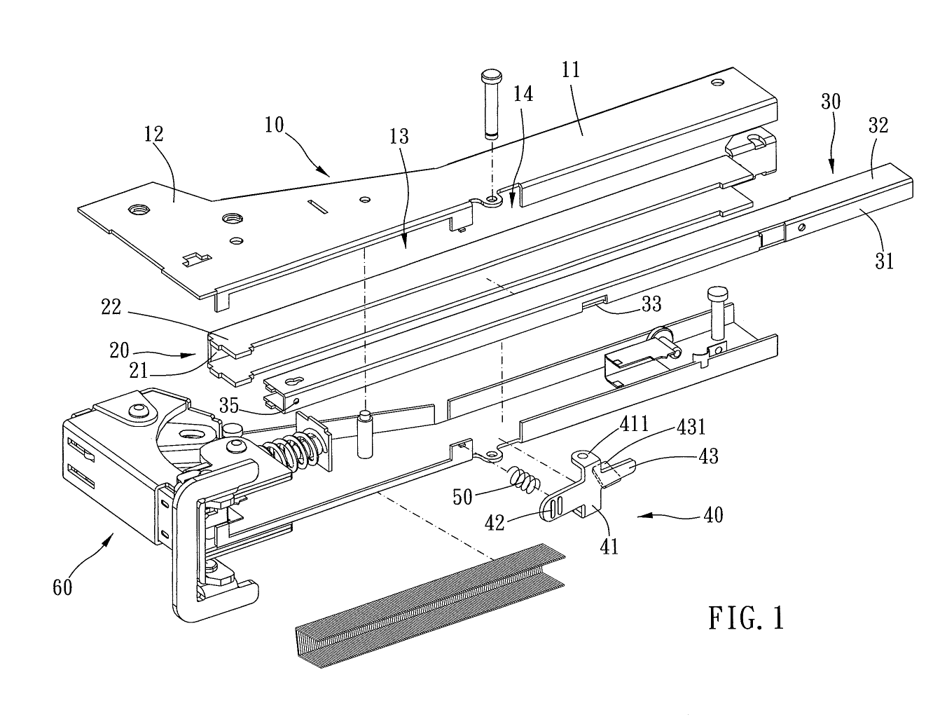

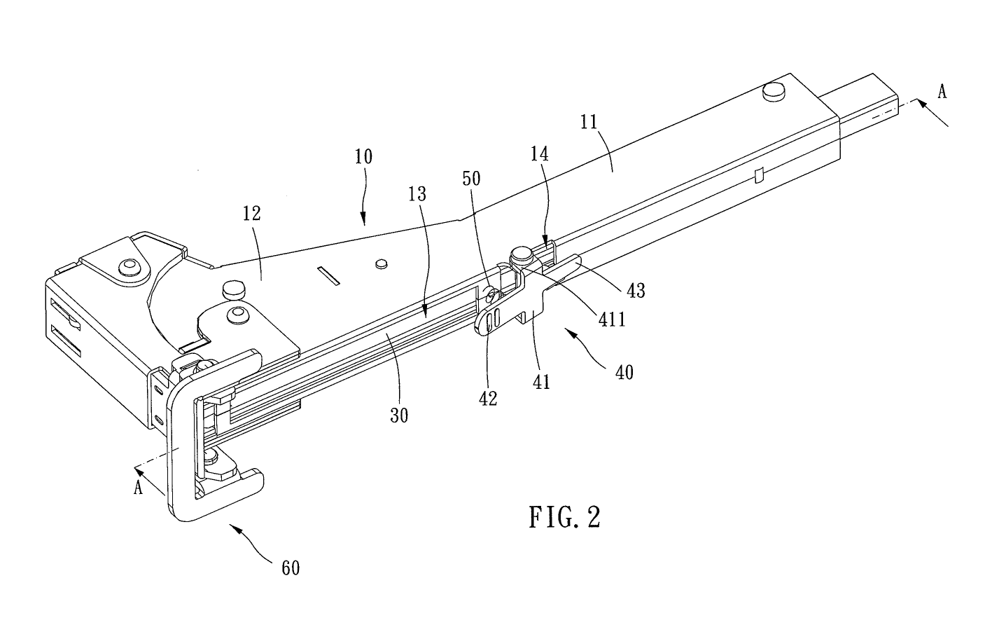

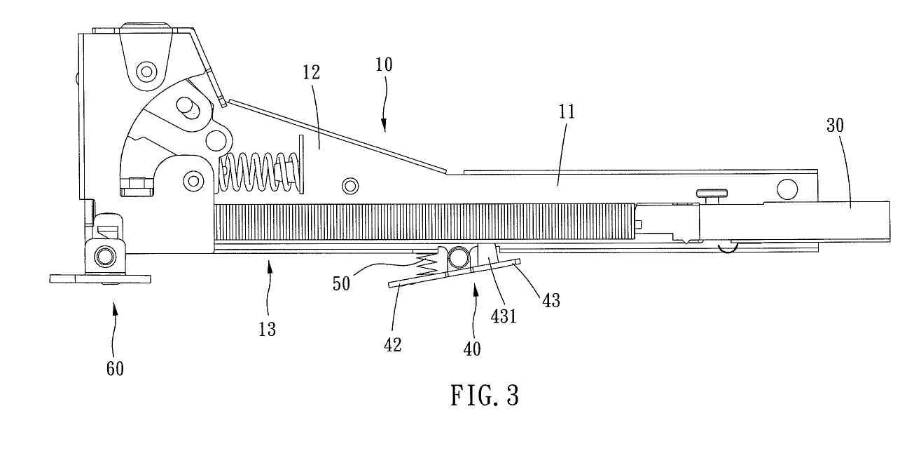

Please refer to FIG. 1 to FIG. 3 for a first embodiment of the present invention. The hammer tacker of the present embodiment includes a shell 10, a receiving tank 20, a magazine 30, a switch 40, an elastic member 50, and a striking mechanism 60.

The shell 10 defines an inner chamber therein. The shell 10 includes a handle 11 and a head 12 which is located at one end of the handle 11. The handle 11 is provided for user to hold. The handle 11 may be covered by elastic or flexible material for comfort purpose. The handle 11 has an opened distal end. The head 12 has a bottom opening 13. More particularly, the shell 10 may include a plurality of plates. In the present embodiment, the shell 10 is constructed by a left plate and a right plate.

The receiving tank 20 is firmly disposed in the inner chamber. The receiving tank 20 has a top surface 21 and two side surfaces 22 extending downwardly from two sides of the top surface 21. The receiving tank 20 defines a space which has an opening facing downward. The bottom opening 13 of the head 12 communicates with the space.

The magazine 30 is slidably received in the receiving tank 20. The magazine 30 has a bottom surface 31 and a track 32 formed upon the bottom surface 31. The magazine 30 and the receiving tank 20 define a receiving slot therebetween. The receiving slot is provided for nailing units to be received therein. Preferably, the nailing units may straddle across the track 32 or erect by the track 32 so as to be kept vertically for striking. The bottom surface 31 is formed with a retaining slot 33. Preferably, the retaining slot 33 is located at a middle portion of the magazine 30.

The switch 40 is disposed on a bottom of the shell 10. The switch 10 is pivotable about an axis. The switch has a pivoting section 41, a press portion 42, and a retaining portion 43. The press portion 42 and the retaining portion 43 are located at two sides of the axis. In other words, the axis is located between the press portion 42 and the retaining portion 43. The pivoting section 41 is located between the press portion 42 and the retaining portion 43. A pair of pivoting slabs extends from the pivoting section 41. The pivoting slabs are rotatably disposed on the bottom of the shell 10, so that the switch 40 is able to pivot with respect to the shell 10. Further, the press portion 42 and the retaining portion 43 are made of a single piece to achieve an operative relationship. One of the press portion 42 and the retaining portion 43 is raised when the other one is pressed. The press portion 42 is provided for user to press so as to determine position of the switch 40. A retaining protrusion 431 extends toward the magazine 30 from the retaining portion 43. The retaining protrusion 431 selectively engages with the retaining slot 33 so as to prohibit movement of the magazine 30. Preferably, the retaining protrusion 431 has a first surface facing the head 12 and a second surface facing the distal end of the handle 11. When the retaining protrusion 431 engages with the retaining slot 33, the first surface is perpendicular to the magazine 30. The second surface may be made chamfered or rounded.

The elastic member 50 exerts a resilient force on the switch 40, so that the retaining portion 43 has a tendency to move toward the magazine 30. More particularly, the elastic member 50 can be disposed between the switch 40 and the shell 10. One end of the elastic member 50 abuts against the press portion 42 to push the press portion 42 raise. In the present embodiment, the elastic member 50 is a coil spring. In other possible embodiments of the present invention, the elastic member 50 may be a torsion spring or other elements which is able to introduce the resilient force.

The striking mechanism 60 is disposed on the head 12. The striking mechanism 60 is adapted for striking the nailing units. More particularly, the striking mechanism 60 may include an operation portion, a striking plate, and a transmission unit. The transmission unit is operated between the operation portion and the striking plate, leading that the striking plate has a movement direction opposite to a movement direction of the operation portion. When the operation portion strikes a target, the transmission unit drives the striking plate to move. The striking plate then strikes the nailing unit forward.

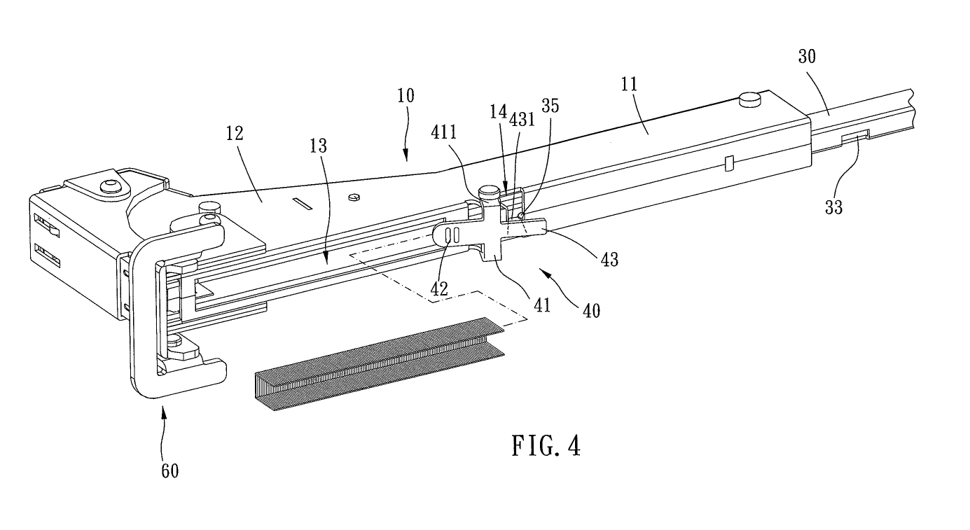

Please refer to FIG. 4. When the press portion 42 is pressed, the retaining protrusion 431 disengages from the retaining slot 33. The magazine 30 then resumes to a slidable condition. The magazine 30 can slide outwardly from the distal end of the handle 11. User can fill nailing units in the receiving tank 20 via the bottom opening 13.

To prevent the magazine 30 from falling out from the receiving tank 20, the present invention may further include an anti-escape means for prohibiting departure of the magazine 30 from the receiving tank 20. For example, the anti-escape means may include a protrusion and a groove which are located on proper positions so as to selectively engage with each other. In the present embodiment, an abutting protrusion 35 is disposed on the bottom surface 31 of the magazine 30. The abutting protrusion 35 is located about a front end of the bottom surface 31. The shell 10 is formed with an aperture 14. The retaining protrusion 431 of the retaining portion 43 can pass through the aperture 14 and abut against the retaining slot 33 or the abutting protrusion 35. As such, when the magazine 30 slides outwardly, the abutting protrusion 35 is able to abut against the retaining protrusion 431. Departure of the magazine 30 from the receiving tank 20 is prohibited.

For convenience purpose, the switch 40 may be located between the handle 11 and the head 12. The switch 40 is then located behind the bottom opening 13. As such, the hammer tacker of the present embodiment can be operated by single hand.

Accordingly, user can operate the hammer tacker with single hand. The magazine 40 slides outwardly after the switch 40 is pressed. User can fill the nailing units via the bottom opening 13 with the other hand. The magazine 40 is then pushed to return the initial position.

To conclude, user can operate the hammer tacker with single hand, and can fill the nailing units with the other hand. Nail units filling is easier and quicker. Further, the magazine can be kept on the shell and the receiving tank. The magazine would not be lost in worksite.

What is claimed is:

1. A hammer tacker, comprising:
a shell, defining an inner chamber therein, the shell including a handle and
a head, the head being located at one end of the handle, the head having a bottom opening;
a receiving tank, disposed in the inner chamber, the receiving tank defining a space, the space having an opening facing downward, the space communicating with the bottom opening of the head;
a magazine, slidably received in the receiving tank, a receiving slot being defined between the magazine and the receiving tank, the receiving slot being adapted for nailing units to be received therein, the magazine having a bottom surface, the bottom surface being formed with a retaining slot;
a switch, disposed on a bottom of the shell, the switch being pivotable about an axis, the switch having a press portion and a retaining portion, the press portion and the retaining portion being located at two sides of the axis, the press portion and the retaining portion achieving an operative relationship, a retaining protrusion extending from the retaining portion, the retaining protrusion selectively engaging with the retaining slot so as to prohibit movement of the magazine;
a striking mechanism, disposed on the head, the striking mechanism being adapted for striking the nailing units;
wherein the retaining protrusion disengages from the retaining slot when the press portion is pressed, so that the magazine resumes to a slidable condition.

2. The hammer tacker of claim 1, wherein the hammer tacker further comprises an elastic member, the elastic member exerts a resilient force on the switch, so that the retaining portion has a tendency to move toward the magazine.

3. The hammer tacker of claim 1, wherein the hammer tacker further comprises an anti-escape means for prohibiting departure of the magazine from the receiving tank.

4. The hammer tacker of claim 1, wherein the hammer tacker further comprises an abutting protrusion, the abutting protrusion is disposed on the bottom surface, the abutting protrusion is able to abut against the retaining protrusion when the magazine slides outwardly, so that departure of the magazine from the receiving tank is prohibited.

5. The hammer tacker of claim 1, wherein the switch is located between the handle and the head, and the switch is located behind the bottom opening.

6. The hammer tacker of claim 1, wherein the switch comprises a pivoting section, the pivoting section is located between the press portion and the retaining portion, and the pivoting section is pivotably disposed on the bottom of the shell.

7. The hammer tacker of claim 1, wherein the nailing units is received in the receiving tank via the bottom opening.
